(19) United States
(12) Patent Application Publication
(10) Pub. No.: US 2026/0251155 A1
(43) Pub. Date: Aug. 27, 2026

(54) ADJUSTABLE COOLANT PUMP WITH ANNULAR SLIDER

(71) Applicant: Nidec GPM GmbH, Auengrund OT Merbelsrod (DE)

(72) Inventor: Franz PAWELLEK, Lautertal (DE)

(21) Appl. No.: 19/401,637

(22) Filed: Nov. 26, 2025

(30) Foreign Application Priority Data
Feb. 27, 2025 (DE) 10 2025 107 571.9

(51) Int. Cl. F04D 29/46; F01P 5/04; F04D 1/00

(52) U.S. Cl. CPC F04D 29/466; F01P 5/04; F04D 1/00; F01P 2025/08

(57) ABSTRACT

An adjustable coolant pump including a pump housing, an impeller, a pump shaft rotatably mounted in the pump housing on free ends of which a belt pulley is provided, and, on an opposite side, the impeller is located in a rotationally fixed manner, and an annular slider located in a pump interior to be acted upon by a compression spring and to regulate an outflow area of the impeller, and a cone valve including a stationary valve sleeve and a valve body. The annular slider is the valve body and the cone valve is configured to influence the outflow area of the impeller.

### CROSS REFERENCE TO RELATED APPLICATION

The present invention claims priority under 35 U.S.C. §119 to German Patent Application No. DE 10 2025 107 571.9 filed on February 27, 2025, the entire contents of which are hereby incorporated herein by reference.

### 1. Field of the Invention

The present disclosure relates to controllable coolant pumps, commercial vehicles each with an internal combustion engine and a cooling circuit and at least one controllable coolant pump, and methods for operating the controllable coolant pumps.

### 2. Background

It is known to use controllable coolant pumps in commercial vehicles to circulate the coolant in a closed circuit through cooling channels in the crankcase and cylinder head of the combustion engine and then to cool it back down in an air-water heat exchanger or radiator.

A coolant pump driven directly by a belt drive is often used for this purpose. Direct coupling between the coolant pump and the crankshaft means that the pump speed is dependent on the speed of the combustion engine. As a result, when the combustion engine is cold started, the coolant circulates, delaying the desired rapid heating of the combustion engine and the associated optimum operating temperature.

Another issue is the frequent oversizing of mechanical water pumps. In order to reliably prevent overheating in driving situations with high engine loads, the pumps are designed with a safety factor. As a result, in most driving situations they deliver more volume flow than necessary, with the undesirable side effect of unnecessarily high energy consumption.

In the course of the continuous optimization of combustion engines with regard to emissions and fuel consumption, it is important to bring the engine up to operating temperature as quickly as possible after a cold start and to maintain it at the optimum temperature. The water pump should generate just enough volume flow to maintain the optimum temperature. This reduces the power consumption of the controllable water pump compared to an uncontrollable pump. This reduces both friction losses and emission values and lowers fuel consumption. To achieve this effect, controllable coolant pumps are used, whose volume flow can be adjusted to the cooling requirements of the combustion engine.

In the commercial vehicle sector, it is common practice to use water pumps with adjustable viscous couplings and switchable eddy current couplings. Both concepts are based on a change in the speed of the impeller.

### SUMMARY

Example embodiments of the present disclosure provide controllable coolant pumps that are cost-effective and save fuel.

A controllable coolant pump according to an example embodiment of the present invention includes a pump housing, an impeller with a pump shaft rotatably mounted in the pump housing, on free ends of which a pulley is located on one side and the impeller is located on the opposite side in a rotationally fixed manner, and an annular slider located in an inner pump chamber to be acted upon by a compression spring and to regulate an outflow area of the impeller of the coolant pump. The controllable coolant pump also includes a cone valve with a fixed valve sleeve and a valve body. The annular slider is the valve body and the cone valve is configured to influence the outflow area of the impeller.

The cone valve improves a volume flow control characteristic when the annular slider is moved, which saves drive energy.

The valve sleeve is preferably made of steel.

Preferably, the valve sleeve includes a truncated cone-shaped portion in areas on an inside, with an opening of the truncated cone-shaped portion facing the annular slider, so that during a closing process, the annular slider is movable into the truncated cone-shaped portion until the annual slider approaches the inside of the valve sleeve in a maximum closed position within the truncated cone. This allows the cone valve to be implemented in a particularly cost-effective and durable manner.

Simulations have shown that the cone angle of the truncated cone is preferably between 5° and 20°, for example. The control characteristic curve is therefore approximately linear. The power consumption of the pump follows the volume flow.

Preferably, the slider travel between fully open and fully closed positions is between 3 mm and 12 mm, with the slider travel within the truncated cone-shaped portion preferably being between 1 mm and 5 mm, for example.

In a particularly advantageous example embodiment, the valve sleeve includes an upper portion and a lower portion, wherein the two portions are connected to each other by connecting webs and the upper portion includes the truncated cone-shaped portion and the lower portion is seated in the pump housing and provides a guide sleeve to guide the annular slider in axial movement. The compression spring may be supported on the guide sleeve. For low-friction guidance, open guide strips may be provided between the guide sleeve and the pump interior and/or between the pump interior and the outer cylinder.

The coolant pump preferably includes an auxiliary pump, preferably an electric auxiliary pump, to draw coolant from the impeller side chamber and feed the coolant at increased pressure to a side of the annular slider facing away from the impeller, such that the annular slider is movable against the spring force of the compression spring. Such an actuator system can be implemented with few, inexpensive components. As a result of the direct actuation of the annular slider, large, hydraulically effective areas are available. The system is robust and durable. The hydraulic force level is preferably so high that the spring force of the compression spring can be set high, which results in a low risk of the slide valve jamming.

Preferably, a hydraulically effective area of the annular slider is configured such that a pressure difference of a maximum of 0.6 bar of the electric auxiliary pump, in particular a maximum of 0.3 bar, for example, is sufficient for movement of the annular slider. The auxiliary pump can thus be particularly inexpensive.

It is particularly cost-effective if the auxiliary pump is a centrifugal pump with an exposed impeller and a suction channel and a pressure channel are provided in the pump housing. It is advantageous if an axis of rotation of the impeller of the auxiliary pump is inclined, in particular, perpendicular to the axis of rotation of the pump shaft.

In addition, a commercial vehicle is provided with a combustion engine, a cooling circuit to cool the combustion engine, and at least one controllable coolant pump as described above, wherein the coolant pump is configured to transport coolant present in the cooling circuit, and the at least one controllable coolant pump is drivable by a belt drive from a crankshaft of the combustion engine.

In addition, a controllable coolant pump is provided with a pump housing, an impeller, a pump shaft rotatably mounted

in the pump housing, on free ends of which a pulley is located on one side and the impeller is located on an opposite side in a rotationally fixed manner, and an annular slider located in an inner chamber of the pump to be acted upon by a compression spring and to regulate an outflow area of the impeller of the coolant pump, wherein the coolant pump includes an auxiliary pump, preferably an electric auxiliary pump, configured to suck coolant from an impeller side chamber and feed the coolant at increased pressure to a side of the annular slider facing away from the impeller, such that the annular slider is displaceable against a spring force of the compression spring. In addition, a filter spring plate is located in the impeller side chamber of the impeller of the coolant pump, which separates the impeller side chamber from an inner chamber of the pump (e.g., an interstitial space) in which the annular slider is movable and which is firmly connected to the pump housing, an edge of the filter spring plate being surrounded by a seal which at least partially seals the impeller side chamber from a pump interior in an area of the annular slider. The seal preferably has a U-shaped cross-section. Preferably, an outer diameter of the seal is larger than an inner diameter of the annular slider, so that the seal fits tightly. The inner diameter of the seal preferably has a clearance relative to the outer diameter of the filter spring plate, so that the annular slider is movable freely despite the seal.

The filter spring plate ensures that the annular slider is held in an open position when the electric auxiliary pump does not generate any pumping force (inactive) (fail-safe).

Preferably, the filter spring plate includes at least one filter bore through which coolant reaches the electric auxiliary pump via a suction line. The at least one filter bore is preferably located approximately parallel to the axial direction (rotation axis of the impeller). As a result, the filter bores are approximately perpendicular to a circular flow in the impeller side chamber, and particles present in the coolant are accelerated radially past the bores and thus do not penetrate through the bores. The coolant is thus pre-filtered.

A sleeve preferably is inserted into the pump housing, which connects to a suction line in the pump housing such that the annular slider is movable on the sleeve with play. This prevents the annular slider from twisting due to circular flow.

The auxiliary pump, preferably an electric pump, and the controllable coolant pump, may preferably be configured as described above.

In addition, a method for operating one of the controllable coolant pumps described above is provided, the method including measuring an actual temperature in a cooling circuit and determining a difference between the actual temperature and a target temperature, calculating a control current for an auxiliary pump based on a temperature difference using a PID controller and pulse width modulation, and controlling the auxiliary pump with the control current.

The electric auxiliary pump thus enables continuous adjustment of the delivery rate of the mechanical coolant pump, regardless of the pump speed.

It is also conceivable to use a position sensor to determine a position of the annular slider and to feed the position back into a volume flow control loop. For this purpose, a multidimensional characteristic map can be stored in the engine control unit, from which the volume flow can be read out depending on the pump speed, the position of the annular slider, the temperature of the medium, and the thermostat position.

In addition, according to an example embodiment of the present invention, a method for operating a controllable coolant pump in a commercial vehicle with a pump housing, an impeller with

a pump shaft rotatably mounted in the pump housing, on free ends of which a pulley is located on one side and the impeller is located on the opposite side in a rotationally fixed manner, and with an annular slider located in an inner chamber of the coolant pump to be acted upon by a compression spring and to regulate an outflow area of the impeller of the coolant pump, includes regular movement of the annular slider into an open position to flush out and remove particles from an interior of the impeller, even if a coolant control system specifies a closed position for the annular slider.

Regular opening, independent of the actual thermal management, flushes particle accumulations under the annular slider into the pressure spiral and prevents the annular slider from jamming. Preferably, flushing takes place at a predetermined time interval. It is also conceivable that flushing only takes place when it is detected that the time elapsed since the last opening exceeds a threshold value.

Controllable coolant pumps according to example embodiments of the present invention can be configured as described above.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of controllable coolant pumps are described in more detail below with reference to the drawings. Identical components or components with identical functions are assigned identical reference numerals.

FIG. 1A shows a longitudinal section through a controllable coolant pump with an annular slider in an open position.

FIG. 1B shows a longitudinal section through a controllable coolant pump with an annular slider in a closed position.

FIG. 2 shows a longitudinal section through an adjustable coolant pump with an electric auxiliary pump.

FIG. 3 shows a detail of the longitudinal section in FIG. 1B.

FIG. 4 shows a top view of a portion of the adjustable coolant pump shown in FIGS. 1A and 1B.

FIG. 5 shows two characteristic curves of the controllable coolant pump of FIGS. 1A and 1B.

### DETAILED DESCRIPTION

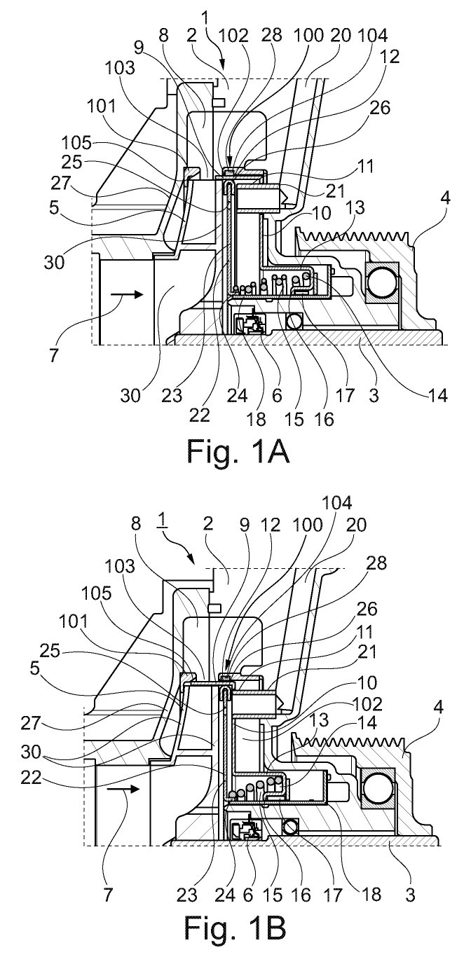

FIGS. 1A and 1B show a portion of a controllable coolant pump 1. The coolant pump 1 includes a pump housing 2 in which the pump shaft 3 is mounted to rotate freely. A pulley 4 is non-rotatably located on one of the two free ends of the pump shaft 3 outside the pump housing 2. A driver of the belt drive connects the pulley to a pulley (not shown) of a crankshaft of a combustion engine. An impeller 5 is pressed onto an opposite free end of the pump shaft 3. The speed of the belt pulley 4 is thus determined by the speed of the impeller 5. On the impeller side, a seal 6 is provided on the pump shaft 3, which separates a coolant-carrying area from a dry area. When the impeller 5 is rotating during operation of the coolant pump 1, the coolant 7 flows axially via a suction connection to the impeller 5 and is fed radially into a pressure channel 8 or spiral channel (not shown). A pump cover connected to the impeller 5 provides a transition between the suction connection and the pressure channel 8. An annular slider 9 is provided to influence the delivery volume of the coolant pump 1. The annular slider 9 includes a circular disc 10 which is seated in a pump intermediate space 11 in the pump housing 2, surrounding the pump shaft 3 in a circular and concentric manner. The circular disc 10 is connected on its circumference to an outer cylinder 12, the inner diameter of which slightly exceeds the outer diameter of the impeller 5. On the inside, the circular disc 10 is connected to an inner cylinder 13, which extends in the axial direction opposite to the outer cylinder 12 and has a contour on the inside with a spring seat 14 to receive a spring 15 and, on the circumference, a bend 16 to receive an open guide band 17. The guide band 17 enables low-friction radial guidance of the annular slider 9 along a guide sleeve 18, which is located on the inside of the pump intermediate chamber 11. The outside of the outer cylinder 12 is also guided axially with low friction by an open guide band in a valve sleeve 100 located in the pump housing. The contact points of the guide bands on the annular slider 9 act as outlet throttles through which the hydraulic volume displaced during the return stroke of the annular slider 9 flows back to the side of the annular slider 9 close to the impeller. The annular slider 9 is designed as a deep-drawn portion.

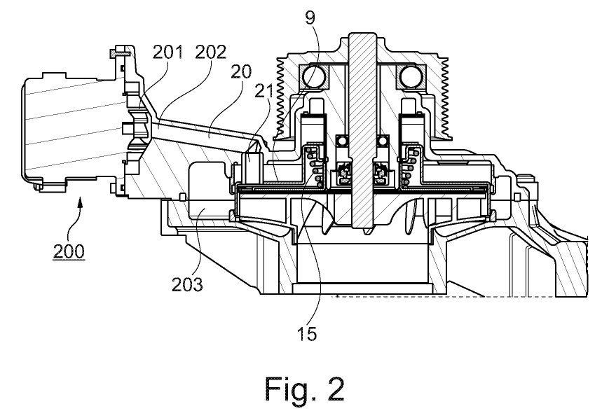

An electric auxiliary pump 200 in the form of a centrifugal pump, as shown in FIG. 2, is integrated into the coolant pump 1. The electric auxiliary pump preferably has an exposed impeller 201 and therefore no spiral cover of its own. A pump spiral is not necessary due to the low flow rate. A concentric circular ring guide device is sufficient. The inlet 202 and outlet of the auxiliary pump 200 are represented by the geometry of the pump housing of the coolant pump 1. The pump housing includes a pressure channel 203, which extends from a radially outer area of the impeller 5 of the electric coolant pump to the pump interior, and a suction channel 20, which extends from a suction nozzle of the auxiliary pump located on the impeller to the pump interior 11. The suction channel 20 is connected to the rear area of the impeller 5 of the coolant pump 1 (impeller side chamber) via a sleeve 21. The sleeve 21 is surrounded on its circumference by the annular slider 9 with some clearance. The sleeve 21 thus prevents the annular slider 9 from twisting due to the flow forces acting in the circumferential direction.

As shown in FIGS. 1A and 1B, a filter spring plate 22 is located in the rear area of the impeller 5 of the coolant pump 1 (impeller side chamber). The filter spring plate 22 includes a circular ring disc 23, which is connected to a circular ring cylinder 24 in the center. The circular ring cylinder 24 is pressed onto the pump housing 2. For reasons of ease of installation, the filter spring plate 22 and the guide sleeve 18 are designed as two components. Both components 18, 22 are pressed onto the housing. The spring 15 is supported by the filter spring plate 22. The spring 15 is a compression spring that pushes the annular slider 9 away from the impeller 5 and holds it in an open position (fail-safe).

The circular ring disc 24 of the filter spring plate 22 extends perpendicular to the axial direction and, in the example embodiment shown, includes a filter bore 25 at the level of the sleeve 21. The filter bore 25 is perpendicular to the circular flow in the impeller side chamber. Preferably, the filter bore 25 is located as far out as possible in the radial direction. Preferably, several filter bores 25 are provided. Due to their high density, particles in the cooling water are preferentially accelerated radially and therefore have little tendency to penetrate the filter bores 25. The electric auxiliary pump thus sucks pre-filtered coolant through the filter bores 25 into the sleeve 21 and through the suction line 20. A filter element at the inlet of the sleeve 21 is therefore not necessary.

The edge of the circular ring disc 24 of the filter spring plate 22 is surrounded by a seal 26. The seal 26 has a U- shaped cross-section and the circular ring disc 24 lies between the two sealing lips. The outer diameter of the seal 26 is larger than the inner diameter of the outer cylinder of the annular slider 9, so that it fits tightly. The inner diameter of the seal has a clearance with respect to the outer diameter of the filter spring plate 22, so that the annular slider 9 can move freely despite the seal 26. The seal 26 prevents the circular flow from passing from the impeller side chamber into the pump intermediate chamber. This ensures that the pressure in the pump intermediate chamber is equal to the pressure in the hydraulic chamber (impeller-remote side of the annular slider) when the electric auxiliary pump is at rest and that no unwanted closing force acts on the annular slider.

The filter spring plate 22 is preferably made of deep-drawn sheet steel. The seal 26 is preferably made of plastic as an injection-molded structure.

The speed of the auxiliary pump 200 shown in FIG. 2 is electronically controllable. As the speed of the auxiliary pump 200 increases, the pressure in the outlet rises. The auxiliary pump 200 always rotates in the same direction. The pressure outlet of the auxiliary pump 200 is directed to the side of the annular slider 9 close to the impeller (not shown) and primarily acts against the spring return force of the spring 15 in the closing direction.

The pressure difference between the inlet pressure and the outlet pressure of the electric auxiliary pump 200 preferably is a maximum of 0.5 bar, in particular a maximum of 0.3 bar, for example. The delivery pressure of the mechanical auxiliary pump 200 does not significantly influence the force balance of the annular slider 9. Due to the large hydraulically effective area of the annular slider 9, even small pressure increases in the auxiliary pump 200 result in large displacement forces. As a centrifugal pump, the auxiliary pump 200 is able to compensate for leakage losses through the design-specific drain throttles in the hydraulic chamber.

For position detection of the annular slider 9 as feedback for a control loop of the auxiliary pump 200, a displacement sensor with target (not shown) can be optionally attached to the annular slider 9.

The movement of the annular slider 9 is explained in detail below.

FIG. 1A shows the maximum open position of the annular slider. The valve sleeve 100 sits on one side in the pump housing 2 and on the other side in the spiral housing 27. The valve sleeve 100 completely surrounds the impeller 5 in some areas along the circumference. The valve sleeve 100 includes an upper portion 101 and a lower portion 102, both of which are connected to each other by connecting webs running in the axial direction. Flow windows 103 are located between the two portions 101, 102 and the connecting webs. In the maximum open position of the annular slider 9 shown, it does not cover the flow windows 103. In other words, the flow windows 103 are completely exposed. The upper portion 101 sits in the spiral housing 27 and the lower portion 102 is inserted into the pump housing 2 with a sliding fit. The lower portion 102 has a recess 104 to receive a guide band 28.

The upper portion 101 is designed to be truncated conical at least in some areas on the inside. The truncated cone 105 opens towards the lower portion (towards the pump housing side). The annular slider 9 acts as a valve body.

FIG. 1B shows the maximum closed position of the annular slider 9. The annular slider 9 completely covers the flow windows 103 and prevents coolant from entering from the impeller 5. During the closing process, the annular slider 9 moves inside and along the truncated cone 105, and the end of the annular slider 9 slowly approaches the fully closed position by the cone angle of the truncated cone 105. This prevents a sudden change in the coolant flow. The same applies to the opening process.

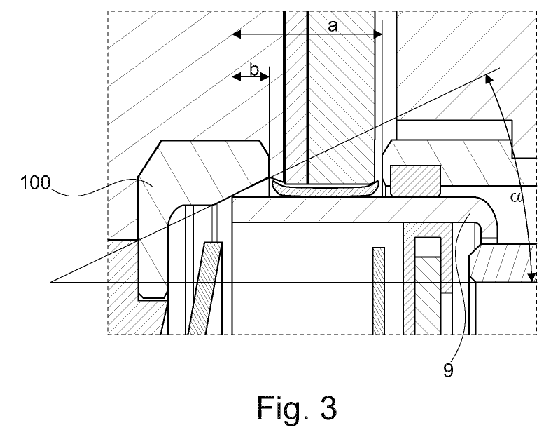

FIG. 3 shows the cone valve with the valve sleeve 100 and the annular slider 9 in detail. The valve sleeve 100 is preferably a steel sleeve. The cone angle is between 5° and 20°, for example. The slider travel a between the fully open and fully closed positions is between 3 mm and 12 mm, for example. The slider travel b within the truncated cone is between 1 mm and 5 mm, for example. In other words, the slider travel b is the distance that the annular slider moves in the axial direction from the end of the truncated cone to the fully closed position (stop of the annular slider on the inside of the upper portion in the area of the truncated cone).

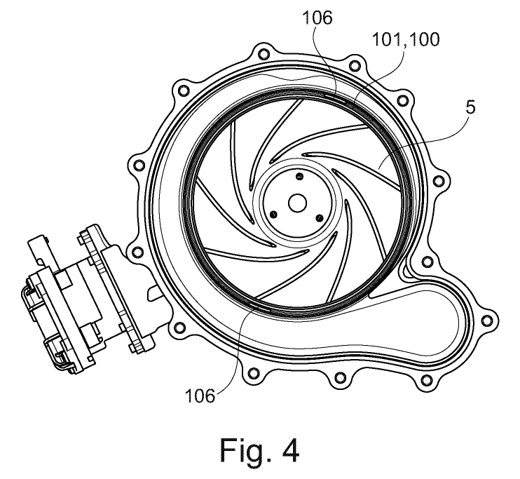

FIG. 4 shows a top view of the exposed impeller 5. The upper portion 101 of the valve sleeve 100 is shown on the circumference, as well as two diametrically opposed connecting bridges 29 that connect the upper portion 101 to the lower portion, which is not visible.

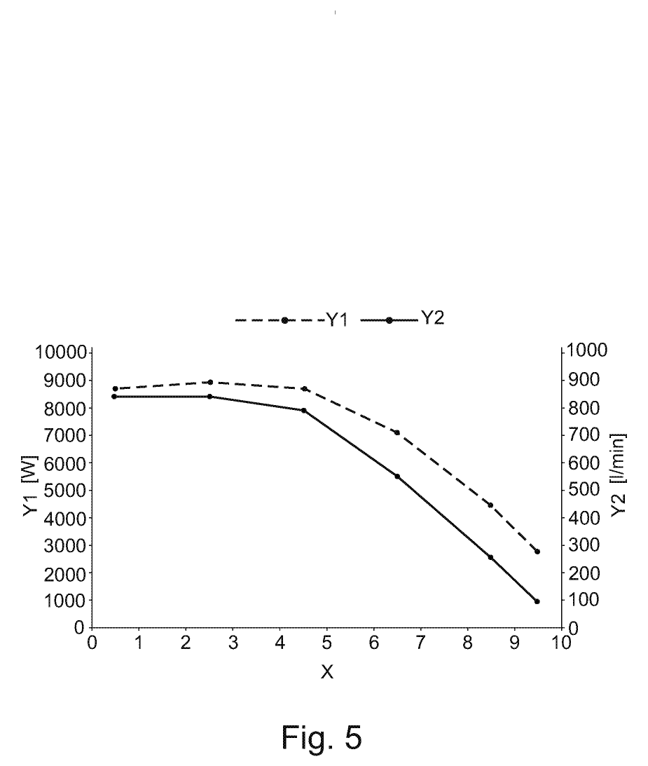

FIG. 5 shows the influence of the valve sleeve on the characteristic curves of the electric coolant pump. The measuring points represent a slider travel a of 9 mm, for example, shown as the x-axis. The dashed line represents the performance curve plotted on the y-axis as y1. The power decreases approximately linearly with increasing slider travel (movement from the open to the closed position). The solid line indicates the course of the volume flow plotted on the second y-axis as y2. The volume flow also decreases approximately linearly with increasing slider travel.

The cone valve thus enables a linear control characteristic of the flow, which is a major advantage.

Regardless of the design implementation, when using an annular slider in a cooling circuit of a commercial vehicle (e.g., truck), it is generally advantageous to provide a flushing function. It has been shown that when the annular slider is closed, as shown in FIG. 1B, particles 30 (circles) in the coolant collect on the inside of the annular slider 9. Since cooling circuits in commercial vehicles, unlike those in passenger cars, can includes a large number of particles 30, the accumulation of particles 30 in front of the annular slider 9 can cause it to jam and impair its function.

To prevent jamming, the annular slider 9 is regularly moved to the maximum open position for flushing, so that all particles (conglomerates) 30 are flushed into the spiral (see FIG. 1A). The flushing position is routinely approached by the control electronics. The rear side of the impeller acts as a disc separator, which largely prevents particles from entering the space between the filter spring plate 22 present in the example embodiments shown.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An adjustable coolant pump comprising:
a pump housing;
an impeller;
a pump shaft rotatably mounted in the pump housing on free ends of which a belt pulley is provided, and, on an opposite side, the impeller is located in a rotationally fixed manner, and an annular slider located in a pump interior to be acted upon by a compression spring and to regulate an outflow area of the impeller; and
a cone valve including a stationary valve sleeve and a valve body; wherein
the annular slider is the valve body and the cone valve is configured to influence the outflow area of the impeller.

2. The adjustable coolant pump according to claim 1, wherein the valve sleeve includes a truncated cone-shaped portion in areas on an inside of the valve sleeve, and an opening of the truncated cone-shaped portion faces the annular slider so that during a closing process, the annular slider is movable into the truncated cone-shaped portion until the annual slider approaches an inside of the valve sleeve within the truncated cone-shaped portion in a maximum closed position.

3. The adjustable coolant pump according to claim 1, wherein a cone angle of the truncated cone-shaped portion is between 5° and 20°.

4. The adjustable coolant pump according to claim 1, wherein travel of the annual slider between fully open and fully closed positions is between 3 mm and 12 mm and within the truncated cone-shaped portion is between 1 mm and 5 mm.

5. The adjustable coolant pump according to claim 1, wherein
the valve sleeve includes an upper portion and a lower portion connected to each other by connecting webs;
the upper portion includes the truncated cone-shaped portion; and
the lower portion is seated in the pump housing and defining a guide sleeve to guide the annular slider in axial movement.

6. The adjustable coolant pump according to claim 1, wherein the valve sleeve is made of steel.

7. An adjustable coolant pump comprising:
a pump housing;
an impeller;
a pump shaft rotatably mounted in the pump housing, on free ends of which a belt pulley is located and opposite thereto the impeller is provided in a rotationally fixed manner, and an annular slider located in a pump interior to be acted upon by a compression spring and to regulate an outflow area of the impeller;
an auxiliary pump to draw coolant from an impeller side chamber and deliver the coolant at an increased pressure to a side of the annular slider facing away from the impeller such that the annular slider is displaceable against a spring force of the compression spring; wherein
a filter spring plate is located in the impeller side chamber and separates the impeller side chamber from a pump interior in which the annular slider is movable, and is connected to the pump housing, an edge of the filter spring plate being surrounded by a seal that at least partially seals the impeller side chamber from the pump interior in an area of the annular slider.

8. The adjustable coolant pump according to claim 7, wherein the filter spring plate includes at least one filter bore through which coolant reaches the auxiliary pump via a suction line.

9. The adjustable coolant pump according to claim 8, wherein a sleeve is inserted into the pump housing and connects to the suction line, and the annular slider is movable with play on the sleeve.

10. A commercial vehicle comprising:
an internal combustion engine;
a cooling circuit to cool the internal combustion engine; and
at least one controllable coolant pump according to claim 1 to transport coolant present in the cooling circuit; wherein
the at least one controllable coolant pump is driven by a belt drive from a crankshaft of the internal combustion engine.

11. A method for operating the controllable coolant pump according to claim 7, the method comprising:
measuring an actual temperature in a cooling circuit and determining a difference between the actual temperature and a target temperature;
calculating a control current for the auxiliary pump by a PID controller and pulse width modulation; and
controlling the auxiliary pump with the control current.

12. A method for operating a controllable coolant pump in a commercial vehicle with a pump housing, an impeller, a pump shaft rotatably mounted in the pump housing on free ends of which a belt pulley is located and opposite thereto the impeller is provided in a rotationally fixed manner, and an annular slider located in a pump interior to be acted upon by a compression spring and to regulate an outflow area of the impeller, the method comprising:
performing regular movement of the annular slider into an open position to flush out and remove particles from an impeller interior, even if a coolant control system specifies a closed position for the annular slider.
